(19) United States
(12) Patent Application Publication
(10) Pub. No.: US 2017/0272703 A1
(43) Pub. Date: Sep. 21, 2017

(54) ATHLETIC PERFORMANCE DATA ACQUISITION SYSTEMS, APPARATUS, AND METHODS

(71) Applicant: GCHD PARTNERS, LLC, Boeme, TX (US)

(72) Inventors: Blake E. Allen, St. Augustine, FL (US); Brent W. Allen, St. Augustine, FL (US)

(21) Appl. No.: 15/338,443

(22) PCT Filed: Apr. 29, 2015
(86) PCT No.: PCT/US15/28287

§ 371 Date: Nov. 5, 2015

Related U.S. Application Data
(60) Provisional application No. 61/986,694, filed on Apr. 30, 2014.
(60) Provisional application No. 61/987,179, filed on May 1, 2014.
(60) Provisional application No. 62/085,528, filed on Nov. 29, 2014.

(51) Int. Cl. H04N 7/18; G06T 7/20; A63B 69/36; A63B 24/00; A63B 71/06

(52) U.S. Cl. CPC H04N 7/183; A63B 24/0062; A63B 71/0622; A63B 71/0669; A63B 24/0021; A63B 69/36; G06T 7/20; A63B 2220/806; A63B 2220/12; A63B 2220/14; A63B 2225/54; A63B 2225/50; A63B 2220/40; A63B 2024/0031; A63B 2024/0034; A63B 2069/3602; A63B 2071/0691; G06T 2207/30224; G06T 2207/30241

(57) ABSTRACT

Systems, apparatus, and methods for capturing data related to athletic performances. Some methods comprise displaying a site map for the performance and accepting a selection of a target for the performance. Various methods comprise estimating, based on the user location, the initial location of the object and recording data regarding the performance. Moreover, some methods also comprise using a satellite-based map as the site map. If desired, the estimating comprises sensing a pause in the changing user location. Some methods further comprise estimating a trajectory of the object using the initial location of the object and a portion of the trajectory. In some scenarios, methods comprise capturing a location of the object at the ending of the performance. The recording can further comprise capturing a video of the performance. Furthermore, these methods can comprise capturing subjective information regarding the performance.

### CROSS REFERENCE TO RELATED APPLICATIONS

This application is a non-provisional of and claims priority to U.S. provisional patent application No. 62/085,528 which was filed on Nov. 29, 2014 by Blake E. Allen et al. and which was entitled GolfCam System Improvements and Modifications; U.S. provisional patent application No. 61/987,179 which was filed on May 1, 2014 by Blake E. Allen et al. and which was entitled GolfCam System; and U.S. Provisional patent application 61/986,694 which was filed on Apr. 30, 2014 by Blake E. Allen et al. and which was entitled GolfCam Monopod all of which are incorporated herein as if set forth in full.

### BACKGROUND

Golf frustrates many people who attempt to play it and even talented, experienced players can experience frustration as they attempt to improve their “game” (i.e., skill level). This situation is so because a golf swing involves complex bio-mechanics of the player's body as well as complicated physics related to the manner in which a ball responds to the club, the way the club responds to striking the ball, the spin of the ball as it flies, aerodynamic effects acting on the ball, the wind, etc. Moreover, subjective factors such as the player's intended target for the ball also have a bearing on each swing. Perhaps, then, it is no wonder then that a player might slice or hook a ball when a straight shot had been desired or vice versa. Likewise, it is no wonder that, for many such “bad shots,” the players fail to understand what went wrong. Thus, for most players, improving their game requires much practice, patience, and persistence.

At higher levels of play (for instance, advanced amateur, professional, “Masters®,” etc. levels) even incremental improvements can yield significant returns. In games/tournaments in which every player plays near, at, or even below par, a savings of a stroke or two per game can be of immense value. Thus, while an incremental improvement might/might not result in a saved stroke for any particular hole, statistically such incremental improvements can drastically increase the chances of winning or at least being more competitive. And, players at these levels often will make substantial investments to improve their game.

### SUMMARY

The following presents a simplified summary in order to provide a basic understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for capturing data regarding athletic performances and more specifically for capturing video recordings of golf swings, related subjective data, and data such as the initial locations of the golf balls, their ending positions, and/or the targets, shape shots, etc. that the golfers intended for such golf swings.

Embodiments provide systems which capture video data of athletic performances in situ with quality levels heretofore only available (if at all) from systems installed at practice stations. More specifically, embodiments provide video capture systems which operate well on golf courses and other venues for athletic performances. Thus, users can acquire video of their athletic performances such as golf swings in the natural, esthetically pleasing environment of a golf course as opposed to the more sedate environment associated with practice tees. Yet, systems of the current embodiment free the users of a need to carry a heavy tripod along with them during their games. Instead, systems of the current embodiment include a monopod (one-legged device) for capturing that video. Such monopods can be light-weight and can fit unobtrusively into the user's golf bag. They include a flex tube with a camera mount for securely holding a camera (or other video capture device).

Embodiments provide robotic systems configured to self-aim and self-focus on the user (golfer, player, etc.). Moreover, systems of the current embodiment also capture the flow-of-consciousness experience of the user on the golf course and allow the user to review the same. Further still, systems of the current embodiment allow the user to transfer, stream, cast, etc. large quantities (even gigabytes) of video data from the camera to computers, televisions, smart televisions, hand-held devices, etc. along with certain subjective data captured by these systems for review.

Many golfers place aesthetic and cathartic value in watching video of their own performance during a golf game (and more specifically, watching their swings). But quality video of their swings is only available (if at all) for swings taken at practice tees in well controlled environments and is usually taken with either expensive equipment customized for such video or with hand held video devices. Thus, with heretofore available devices, players must pay exorbitant prices for quality video or make do with amateurish “selfies.” Systems of embodiments provide video with sufficient quality to avoid problems associated with “selfies” and to provide sufficient insight into the player's moves so that the player can understand their motion(s) during their swings. Such systems also allow the players to seamlessly capture objective data (often including video), subjective data, and/or “intent” related data which heretofore available devices fail to capture.

Many such systems comprise video capture devices, means to hold the video devices, means to control the video devices, etc. In some systems, video capture devices embedded in, incorporated in, hosted in, residing in, etc. convenient devices such as smart phones are used to capture video. Furthermore, the means to hold these devices can further comprise standard camera mounts which are securely attached to the player's golf bags. However, these holding means can be manufactured as (integral) parts of the golf bags. In some embodiments, the holding means are lightweight and mount un-obtrusively in the golf bags. Thus, golfers can use their bags (for instance, inserting and/or removing clubs therefrom) without affecting the mounting of the video capture devices. Further still, the holding means can comprise flex-arms (e.g. “gooseneck” arms) so that the video capture devices can be oriented to capture video of the golfers despite being housed in/on the golf bags.

Systems of embodiments, moreover, comprise golfer finding means. These finding means allow the system to point the video capture devices toward the golfer and to find the image of the golfer in the incoming video data. These finding means can include geo-positioning/orientation-detection circuits associated with the video capture devices and/or remote control devices carried by the golfers. In the alternative, or in addition, these systems can include machine vision capabilities that serve to find the golfers and to determine the distances thereto.

Systems of various embodiments enable athletes to enhance their performance by capturing and/or analyzing mixtures of various subjective data and/or various objective and/or observed data (some of which is non visual in nature) and more specifically video (and/or multimedia data). The subjective data can include information related to the athlete's target, the athlete's thought process in selecting that target, the athlete's rating of their performance during their execution, etc. This combination of data can enable long-term, consistent improvement in the athlete's performance. Indeed, systems of some embodiments support simultaneous capture of visual, objective, and subjective data indicative of athletic performance.

Such systems can enable performance improvements among amateur, avid, professional, etc. athletes. Systems of various embodiments provide suites of software and/or hardware products which empower individual athletes to capture, store, catalog, and/or analyze (in high definition if desired) video of themselves as they play/perform their sports and more specifically in situ on the field of play. Moreover, systems of some embodiments make the process of gathering and viewing such video data user-friendly enough that even technically averse players can use these systems effectively and intuitively.

Systems of various embodiments comprise technology components such as:
Software/firmware applications resident on devices typically carried onto/into the performance sites.
Remote controls for the applications.
Devices housing the aforementioned applications as well as hardware related to the capture of video data.
Pan/tilt adapters.
Viewing and/or “re-play” applications/devices.
Practice systems, modules, and/or accompanying applications and associated hardware.
Associated software systems and algorithms for calculating club selections, shot types, scoring, etc. for storage with the captured video and user data.

More specifically, in the current embodiment, an application captures in-play data and video (for instance, in-round data during a golf game) using a user-supplied smart-phone, smart camera, or other smart video device. Data gathered by the application includes the identity of the club used (for golfing scenarios), score, geo-location, etc. and usually two other data elements 1) video data of athletic performances and 2) geo-locations of the athlete's selected targets for the athletic performance. For instance, the application can capture a golfer's intended target/destination for an upcoming shot and a video of the shot. Moreover, the application of the current embodiment captures subjective data from the golfer such as a rating of how well they feel they concentrated on the shot and/or how well they feel that they executed the shot (sometimes referred to as “concentration scores” and “execution scores” respectively). If desired, the application can be configured to capture such data while minimizing, reducing, or avoiding potential effects on the athlete's pace of play.

Moreover, in accordance with embodiments, video recorders can be placed in a sports accessory such as a golf bag and can be configured to host the application if desired. Furthermore, a multimedia receiver can be used in conjunction with a monopod (and/or camera mount) of the current embodiment to allow the monopod to be used with many such accessories as if it were one of a number of sports-related implements held by that accessory. For instance, the monopod/receiver could be placed in a golf bag as if it were a golf club (without necessarily requiring modifications to the golf bag). Further still, the monopod can be made of aluminum, carbon fiber, other composite materials, titanium, etc. to reduce its weight thereby facilitating a user's ability to carry it whether they are walking, running, riding a vehicle or animal, etc.

Monopods of embodiments can include mechanisms to adjust the monopod's height, center-line offset, etc. so that it can be placed in the proximity of the user (and/or athlete) without a great deal of precision/accuracy while adjustment mechanisms allow users to align the recorder onto the athlete. Thus, the recorder can be placed out of the way yet still be positioned/oriented to record data regarding the athlete's performance. If desired, monopods of the current embodiment can include onboard batteries for the recorders and/or other devices to (at least partially) alleviate power related concerns related thereto.

It might now be helpful to consider some aspects of the viewing application of the current embodiment. The viewing application can be configured to replay, analyze, and/or manage the multimedia data recorded by systems of the current embodiment. The viewing application can be built on an HTML5-CSS (Hypertext Markup Language 5-Cascading Style Sheet) architecture using cloud service infrastructures to facilitate replay of the multimedia (and other data) collected by systems of the current embodiment. Of course, other architectures could be employed and are within the scope of the current disclosure. The viewing application can allow users to replay on-course videos with synchronized satellite maps of their play and/or data analytics of the same. It can therefore create an augmented reality (AR) perspective of the athlete's in situ performance and in which the user can replay their performance, round, at-bat, pitch, run, jump, block, tackle, slap-shot, free throw, etc.

In some embodiments, the viewing application computes/estimates and/or displays a visual/color-coded trajectory of the ball, puck, or other projectile involved in various athletic performances. That trajectory can be estimated/approximated based on combinations of the athlete's initial position (and inferentially the projectile's initial position), an ending position of the projectile (and/or geo-location thereof), the target for the projectile, multimedia data (for instance, video frames/visual data) captured from an initial/early portion(s) of the projectile's flight/movement, etc.

The viewing application of embodiments allows users to load their multimedia files into “cloud” storage locations of their choice and/or share their files with other members of online communities associated with their given sport(s). In appropriate situations, the viewer application also allows users to combine their recorded performances, plays, rounds, etc. with those of other players for simultaneous/synchronized “mashed-up” playback more or less as if they were playing (or had played) together.

The viewing application of the current embodiment combines data regarding the athlete's intended target (for selected athletic performances such as golf swings) with video data of these performances and the resulting trajectory and ending locations for the projectiles and displays the combination for the user/athlete. It also provides analytics of the distance to the target/ending location and the accuracy of the athletes during their performances. The viewing application, moreover, enables the athlete to overlay selected golf courses with statistical representations of their games so that they can (if desired) prepare for competition at any level or just for leisure purposes. Thus, the viewing application goes beyond “greens-in-regulation” and “driving stats” approaches in its data analysis/display capabilities.

In accordance with the current embodiment, a practice module works with the remote control to conveniently capture simultaneous streams of synchronized multimedia data at the practice tee. It also presents this multi-stream, synchronized data in a format suitable for users employing convenient devices such as smart phones, tablets, and/or other mobile devices. Practice systems of the current embodiment allow users to take video segments of one or more swings in a “session” and have the system catalog the files such that the files have human readable names to enable easy retrieval for viewing and/or other purposes. The catalog feature enables a search capability whereby a collection of video segments can be obtained by club used, date, tag name, etc. Shot tracing capabilities provided by some practice systems can be utilized to show initial trajectories off the club faces with the ability to show several trajectory images in a single overlay (for comparison and/or other purposes). Some embodiments provide for using color coded wearables on various spots on the golfers' bodies in conjunction with machine vision algorithms to follow specific points on the their bodies through their golf swings. Other features, such as side-by-side comparisons in slow motion and frame-by-frame playbacks are provided by some embodiments. Furthermore some practice systems capture video with two (or more) cameras positioned to view the user at differing angles during their swings. Such systems provide playbacks of the differing views presented side-by-side and/or in slow motion, frame-by-frame, etc. modes

As to the pan/tilt adaptor of many embodiments, it provides automated tracking of the athletes as they move about the course and/or perform their athletic feats. It therefore eliminates the need to pre-frame the camera(s) (or other multimedia recorders) in the system for data/video capture. The pan/tile adaptor of the current embodiment also includes abilities to track a plurality of athletes.

Thus, various systems provided herein at least partially solve problems associated with capturing video data using cumbersome equipment (for instance, tripod mounted cameras) while also providing multimedia data capturing capabilities which surpass anything heretofore available. Users can avoid clumsy approaches to capturing video such as handing heretofore available smartphones to others who might/might not be skilled photographers and/or jamming tripods into the ground to obtain hopefully steady video.

Systems of the current embodiment also capture a full spectrum of data associated with the performance of various athletes. These systems augment captured objective data with subjective measures/data to provide more complete solutions than heretofore available. Furthermore, systems provided herein allow more accurate measurement of the initial and ending locations of various athletic performances than has been previously available. For instance, in golfing scenarios, these systems avoid unreliable ball location markings by taking a measure of the ball's location at the time the athlete swings rather than when the user instructs the system to mark the ball (which usually occurs at a different time than when the golfer swings and/or perhaps a different location). Systems of the current embodiment also use algorithms disclosed herein to begin tracking the performance based on the athlete's location at the time their performance began. These algorithms can be based on the rate of change of the athlete's position, (and duration of those rates) as they occur during a capture window.

Moreover, embodiments provide mounting systems for the camera/mobile device. For instance, some mounting systems are built-into golf bags while other mounting systems operate independently of the golf bags. These mounting systems can include a flex-arm and/or onboard power supplies.

Further still, systems of embodiments collect various types of data. For instance, some systems capture video and/or intended target, intended shape-shot, etc. types of data. Systems can also (or in the alternative) capture user-observed conditions (and their strength, severity, etc.) such as the wind and/or the elevation associated with particular shots. Systems, furthermore, can capture objective and/or empirical data such as the types (or identities) of clubs, shot shapes, scores, etc. associated with various shots. Systems of various embodiments capture subjective information such as a user's concentration and/or self-evaluated execution for various shots. Many systems capture geo-location data associated with at least one action point during a game(s). Of course, systems of embodiments can capture more/less data without departing from the scope of the disclosure. In accordance with embodiments, some methods comprise accepting a user selected type of club for a shot. Methods of the current embodiment can comprise accepting a user selected set of observed natural conditions and/or a user-input score for at least a hole.

Methods of embodiments comprise determining certain information. For instance, some methods comprise determining one or more types of clubs (and presenting the determined types of clubs to a user) for various shots. Methods, moreover, can comprise determining a type of shot played on a shot and/or a score of a user for at least one hole. Various methods comprise presenting a visual cue to a user whereby the user can orient a video capture device in such a manner that the video capture device frames a ball.

Embodiments provide athletic performance data acquisition systems, apparatus, and methods. More specifically, some embodiments provide systems for capturing athletic performance data which comprise remote controls and video controllers. The remote controls of the current embodiment further comprise geo-location circuits and user inputs. The geo-location circuits are configured to determine the geo-location of the remote control while activating the user input causes the remote control to transmit a signal indicative of that geo-location. The video controllers are in communication with the remote controls and further comprise processors and memories. The processors perform methods further comprising detecting signals indicative of the activation of the user inputs. These methods also further comprise, responsive to the activation of the user inputs, storing the geo-locations in the memories and sending a signal indicating that video should be captured.

Systems of some embodiments further comprise video capture devices (for instance, smart phones) which are configured to receive the signals indicating that video should be captured. Moreover, some systems further comprise pan and tilt units and the methods further comprise causing the pan and tilt units to point toward the geo-locations of the remote controls. Methods of the current embodiment further comprise receiving a plurality of time stamped geo-locations from the remote controls. Such methods can also comprise analyzing the plurality of time stamped geo-locations to determine particular geo locations at which the remote controls paused in their movements for pre-selected times.

In addition, or in the alternative, some methods further comprise capturing video of an initial trajectory of balls. Such methods can also comprise receiving geo locations of the balls at the end of their trajectory. Furthermore, some methods further comprise estimating the trajectories of the balls based on the geo locations at which the remote controls paused, the video data of the initial trajectories of the balls, and the geo locations of the balls at the end of their trajectories. Moreover, methods in accordance with embodiments further comprise accepting user selected and/or intended targets for the balls and/or intended shot shapes for the balls as well.

Various embodiments provide methods for capturing athletic performance data. For instance, some methods comprise detecting signal indicatives of activations of user inputs from remote controls. These remote controls are configured to be carried by users and further comprise geo-location circuits which are configured to determine geo-locations of the remote controls. The remote controls of the current embodiment further comprise user inputs, which when activated cause the remote controls to transmit the signals indicative of those activations as well as signals indicative of their geo-locations. Responsive to the signals indicative of the activations, these methods further comprise storing the geo-locations in memories. Further responsive thereto, these methods further comprise sending signals indicating that video should be captured (using processors in communication with the remote controls and memories).

In accordance with some embodiments, methods are provided for capturing data related to an athletic performance of a user. Such methods comprise various activities such as displaying a map of a site for the athletic performance and accepting from the user a selection of a target on the site and for the object of the athletic performance. These methods also comprise estimating, based on a starting and/or initial location of the user, a location of the object and recorded data regarding the athletic performance of the user. Furthermore, these methods further comprise outputting the recording of the athletic performance of the user.

Moreover, some methods also comprise accepting a satellite-based map of the site of the athletic performance and using the satellite-based map as the map of the site for the athletic performance. If desired, the estimating of the initial location of the initial of the object can further comprise sensing the location of the user. In addition, or in the alternative, the sensing of the location of the user further comprises sensing a pause in a change of the location of the user. Further still, the athletic performance can comprise propelling the object toward the target. Some of these methods further comprise estimating a trajectory of the object using the estimated initial location of the object and a track of at least a portion of the trajectory. In some scenarios, these methods further comprise capturing a location of the object at an ending of the athletic performance and using the captured ending location in the estimating of the trajectory of the object. In some of these methods, the recording of the data further comprises capturing a video of the athletic performance of the user. These methods can further comprise capturing subjective information from the user regarding the athletic performance.

Various embodiments provide systems/apparatus for performing such methods. Systems of these embodiments comprise processors, displays, and memories in communication therewith and which store processor executable instructions for performing such methods.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other advantages and novel features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually identifies the figure in which the reference number first appears. The use of the same reference numbers in different figures indicates similar or identical items.

FIG. 1 illustrates a site for an athletic performance.

FIG. 2 illustrates an athlete and athletic performance.

FIG. 3 illustrates a system for capturing data regarding athletic performances.

FIG. 4 illustrates a block diagram of a system for capturing data regarding athletic performances.

FIG. 5 illustrates a flowchart of a method for capturing data regarding athletic performances.

FIG. 6 illustrates a map of an athletic game.

FIG. 7 illustrates a computer for use in capturing data regarding athletic performances.

### DETAILED DESCRIPTION

The current disclosure provides systems, apparatus, methods, etc. for capturing data of athletic performances of users and more specifically for capturing video recordings of golf swings, related subjective data, and data such as the initial location of the golf balls and the intended targets for those golf balls.

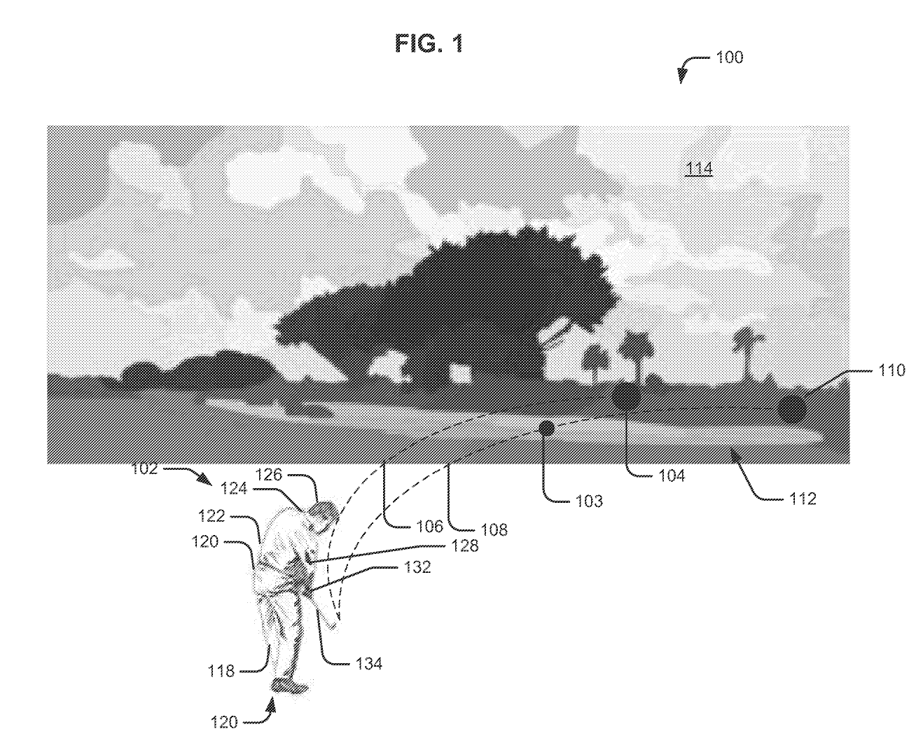

FIG. 1 illustrates a site for an athletic performance. Generally, FIG. 1 serves to illustrate some aspects of systems, apparatus, and methods provided herein for enabling the athlete 102 to improve their performance. But, more specifically, FIG. 1 illustrates a site 100, an athlete 102, a projectile 103, a target 104, an intended trajectory 106, an actual trajectory 108, an actual ending location 110, hazards 112, environmental factors 114, a stance 116, legs/knees 118, waist/hips 120, torso 122, a neck 124, a head 126, arms/elbows 128, wrists/hands 132, and a club 134.

With continuing reference to FIG. 1, the athlete 102 could be interested in improving their performance in any number of sports including (but not limited to) golf, baseball, football, tennis, etc. These sports involve potentially deceptively simple physical acts such as hitting a ball, catching a ball, etc. These actions, however, often involve a complex interplay of factors related to not only the physics of the objects of the game (for instance, the aerodynamics of the ball in flight) but also potentially complex mechanics of the athlete's body as the athlete 102 executes some act or performance in the course of the game, match, set, etc. Thus, at times, the results of the athlete's performance will not match the athlete's intent for that particulate performance.

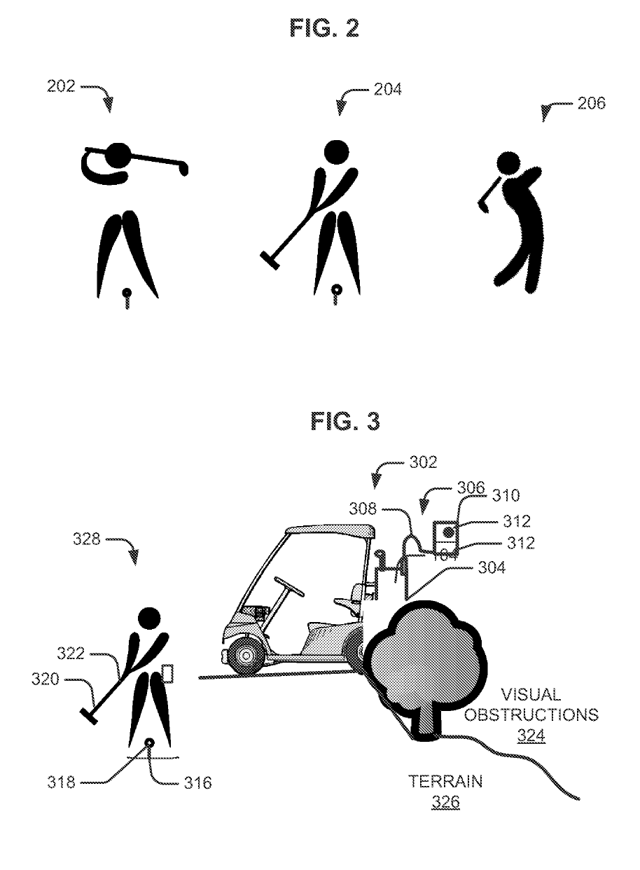

FIG. 1 illustrates such affects by the difference between the intended trajectory 106 and the actual trajectory 108 of the projectile 103. In the athletic performance of FIG. 1 the sport happens to be golf with the athlete 102 being a golfer taking a golf shot with the club 134. The athlete 102, of course, evaluates the course or site 100 to determine what the intended trajectory 106 ought to be to obtain the likely best result for that particular shot. In golf, some likely factors that might influence the user's thought process include those related to the environment such as the presence/absence of precipitation, the temperature, the elevation as a stand in for nominal air density, the direction, strength, and/or variability of the wind, etc. (or in other words environmental factors 114). Other factors include those which are either hazards 112 or might otherwise suggest to the golfer to aim the ball in one direction (or along one path) or another. For instance, hazards 112 include sand traps, bodies of water, trees, bushes, weeds, crowds (and/or other people), buildings, etc. With reference now to FIG. 2 some comments regarding the athlete 102 might be helpful at this juncture.

FIG. 2 illustrates an athlete and athletic performance. More specifically, FIG. 2 follows the athlete 102 through a particular athletic performance, here, a golf swing. Generally, the swing includes various phases such as a top swing 202, a down swing 204, a bottom swing 206, an impact/contact, and a follow through. During these phases, many golfers are attempting to impart a precise amount of energy (sometimes maximized) to the ball as they can and in a consistent manner with a consistent or at least predictable trajectory. And therein lies many of the difficulties players encounter when attempting to learn golf or to improve their game.

A golf swing is a complex physical feat involving many motions that the player wants to coordinate. At one perhaps simplistic level, a golf swing can be modeled as a double pendulum with the shoulders (acting as a pivot point) and arms being one pendulum and the wrists (or thereabouts) and the hands/club 134 forming the other pendulum. These pendulums are attached to each other in a complex bio-mechanical system involving nearly all parts of the athlete's body particularly considering that the player's legs, hips, torso, etc. generate a significant portion of the motive force powering the swing. Thus, all aspects of the player's body can come into play including the player's stance, alignment, grip, timing, etc. This is true to varying extents no matter the type of swing or shot involved: chip, pitch putt, drive, etc. For instance, it is known that the timing of the “uncocking” of the wrists or the “release” (if performed at all) can have a significant effect on a drive.

With continuing reference to FIG. 2, such factors (and/or others) have effects on how the club 134 impacts the ball. And that contact affects the manner in which the ball leaves the tee/club 134 including its initial direction, spin, etc. Of course, the nature of the club 134 and ball also play roles in these events. For instance, many club 134 heads have lie angles, certain “restitution” related properties, shaft lengths, etc. which complicate the physics involved in typical golf swings and of course the balls themselves do so too. For instance, many drivers (clubs) now possess relatively thin cross sections that, despite their metallic nature, create a “trampoline effect” during the usually elastic collisions between the club 134 and the ball. The flexing of the ball and club 134 (head) during these events leads to energy being imparted to the ball efficiently.

And once the ball leaves the tee/club 134 further complexities affect the shot. For instance, the dimples present on many golf balls act to increase turbulence in the boundary layer of air around the ball and/or the onset of turbulence. Combined with the back spin imparted on many balls, the dimples create an affect often termed “Magnus lift” that literally causes the ball to lift higher than would otherwise be the case. Given the increased lift and given the decrease in horizontal velocity due to air resistance, golf balls typically do not follow ballistic, parabolic paths. Rather, they tend to follow “impetus trajectories.”

However, to differing extents, hitting the ball correctly and consistently evades many players at many levels of play. As a result, the ball often leaves the club 134 with less (or more) energy than desired, less/more back spin than desired, at an unwanted angle, with unwanted (counter) clockwise spin, etc. The result is that the ball drops short, over shoots, and/or deviates from the intended trajectory by traveling either to the right or left therefrom. Colloquially, the ball hooks, slices, pulls, draws, fades, etc. Which is not to say that these trajectories are necessarily bad. Indeed, at times a player might intentionally want to cause a ball to follow one of these trajectories to (for instance) avoid a hazard, counter act some environmental factor 114, to obtain a desired lie, etc.

With reference again to FIG. 1, a golfer typically selects both a target 104 or lay for a shot and an intended trajectory 106 or shape shot. If the player executes well, the actual trajectory 108 will bring the ball to its resting, actual ending location 110 in relatively close proximity to the target 104. However, for a variety of reasons the player might not execute so well. As a result, the actual trajectory 108 can depart significantly from the intended trajectory 106 resulting in an actual ending location quite different from the target 104. Of course, “quite different” is a relative term and to a casual athlete it might mean one thing (somewhere “not in the water”). To a professional, avid, or other athlete it might mean within a “club's length” or less. To avoid these relatively negative results, players typically aim to be consistent in their swings and therefore in the results. To be consistent, however, often requires practice and/or (detailed) knowledge of how the player executed previous swings. GCHD Partners, LLC of Cheyenne, Wyo. offers systems able to capture and provide such information to athletes such as, but not limited to, golfers.

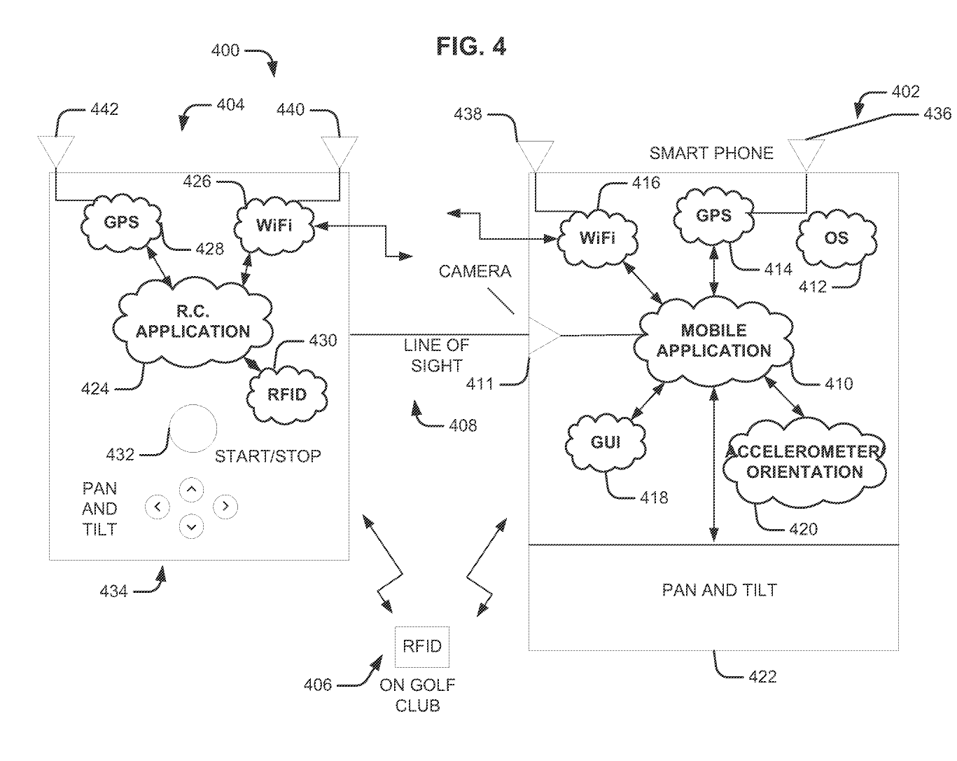

FIG. 3 illustrates a system for capturing data regarding athletic performances. In addition to the other golfing equipment that they might be willing to carry, users might also be willing to carry some equipment to capture hole-by-hole subjective and objective data regarding their game. Thus, FIG. 3 illustrates such a system 300, a golf cart 302, a golf bag 304, a monopod/carrier 306, a goose neck 308, a mobile device 310, a camera 312, a remote control 314, a tee 316, a ball 318, a golf club 320, an RFID circuit 322, a visual obstruction 324, terrain 326, and a golfer 328.

Of course, the visual obstructions 324 and/or terrain 326 can complicate attempts to obtain video of the golfer 328. More particularly, the visual obstruction 324 can be any number of features typically found on golf courses and/or other sites for athletic performances. In some cases, a particular visual obstruction 324 might be a berm, a tree, shrubbery, other athletes, etc. As a game/round develops, particularly when the golf bag 304/monopod 306 are cart-mounted, these visual obstructions 324 can be found between the camera 312 and the golfer 328 from time to time. The monopod 306 and goose neck 308 can allow the golfer 328 to reposition/reorient the camera 312 to have a field of view to the golfer despite the video obstructions.

On a somewhat different note, the terrain 326 might also, or in the alternative, complicate attempts to obtain video of the golfer 328. For instance, in situations in which the golf bag 304/monopod 306 are cart-mounted, the terrain 326 itself might become/be a visual obstruction 324. In other situations, the terrain 326 might impose limits on the positioning/orientation of a camera directly mounted to a cart. For instance, the cart might be restrained (by course rules) to remain on a paved path and/or the terrain 326 might tilt the cart (and camera 312) into a particular orientation. In the current embodiment, though, the height/length of the monopod 306 and the flexibility of the goose neck 308 or flex arm allows the camera 312 to see over/around many such visual obstructions 324 despite the terrain 326 on many courses, at many holes, on many fairways, near many hazards, etc. Indeed, the flex arm can also serve to allow the camera to be oriented such that it has a clear view despite being mounted on/in the golf bag. At this juncture, it might be helpful to now consider some aspects of system 300 in more detail.

For instance, FIG. 3 illustrates the monopod 306 of the current embodiment. In general, the monopod holds the mobile device 310 (including its internal/onboard camera 312) in a user selected and (at least momentarily) fixed position. The goose neck 308 aids in this respect in that it holds the mobile device 310 and couples it to the golf bag 304. It also possesses both sufficient resiliency and flexibility that the golfer 328 can conveniently reposition/reorient the mobile device 310 (or camera 312) and then allow the gooseneck to hold it in a fixed position during a particular shot. The goose neck 308 can be fashioned from a flexible steel or aluminum tube covered in a vinyl material. Further, the tube can be hollowed on the inside to accommodate the installation of cables for various purposes including data and power transmission. It can also include (or work in conjunction with) a coupling and/or coupling structure to couple it to the golf bag and maintain it in fixed relationship thereto. In some embodiments that coupling structure can receive the monopod 308 and can be deemed a receiver 330 as a result. Moreover, the golf bag 304 of embodiments can be equipped with ballast so as to improve its stability during movement on the golf cart 302, as it is being carried by the golfer 328 (and/or other user), while its stationary, etc.

With continuing reference to FIG. 3, the mobile device 310 can be a number of different objects. But, it has been found that currently available smart phones provide adequate functionality in that many of them contain onboard cameras 312, (micro) processors capable of executing applications, transceivers (for instance WiFi transceivers) etc. The onboard cameras 312 of the current embodiment (in conjunction with other features of the mobile devices 310) can capture video of the golfers 328. However, these capabilities (at least in the current embodiment) are often of comparatively low resolution, low frame rate, etc. at least as compared to other camera typically used to capture professional athletic performances in highly competitive and/or well-funded environments such as those used in the ProTracer™ system employed by television broadcast entities producing content at US and European PGA (Professional Golfers Association) events.

Yet, in part perhaps due to aspects further disclosed elsewhere herein, systems of the current embodiment provide better shot tracking capabilities heretofore available. For instance, at least some machine vision based systems will track the divot of particular shots rather than the ball. Some/other heretofore available systems will lose track of the ball in the sun (when sun-facing). In both (and/or other situations) these heretofore available systems will track objects other than the ball. Systems of embodiments avoid these situations. Moreover, they do so without the cumbersome and/or expensive course instrumentation systems that ProTracer™ and other heretofore available systems require. Indeed, in accordance with embodiments, systems identify the starting and ending locations for the ball involved in particular play(s) and using them as mathematical “initial conditions” for curve fitting routines adapted to estimate the trajectories of the balls. These routines, programs, modules, etc., furthermore, use data regarding the trajectory of the ball captured in the initial frames of a given shot (in which machine vision capabilities in the system recognize and/or find the image of the ball) to estimate the trajectory of the ball. This estimated trajectory can then be played back after the fact for player review.

The remote control 314 illustrated by FIG. 3 allows the golfer 328 to communicate with the mobile device 310 and/or an application resident thereon for capturing video at user selected times. More specifically, the remote control can include a switch which triggers a transmission to the mobile device 310 indicative that the golfer 328 desires the camera 312 to begin recording video. It can also include circuitry to support this feature as well as a pan/tilt group of controls for remote control of the camera 312, the goose neck 308, and/or other pan/tilt mechanisms which might be incorporated in the system 300 to orient the camera 312. It might also include circuitry to generate a homing signal to aid the camera 312 in tracking the location of the golfer 328. Moreover, in some embodiments, it includes geo-positioning circuitry to aid in determining the location of the golfer 328. Further, the remote control 314 can include a clip, fastener, belt, strap, etc. adapted to affix the remote control 314 to the golfer 328 (or some article of clothing or appurtenance associated with the golfer 328).

In some embodiments, the system includes a machine vision application(s) for finding the image of the golfer in the incoming video stream. These machine vision applications can be based on artificial intelligence circuits such as neural networks, fuzzy logic, pattern recognition functions, inference engines, heuristic functions, etc. Moreover, they can be trained to find the image of the golfer and/or estimate the range from the camera to the golfer. With knowledge gained from the geo-positioning circuits and/or orientation circuits in the system, these machine vision applications (and/or other components of the system of the current embodiment) can determine the geo-location of the golfer and/or golf ball. Thus, the system can obtain a relatively accurate initial location for the golf ball.

In some embodiments, these functions can also be trained to recognize the golf club or perhaps its shaft and/or head. More specifically, the linear shape of the shaft can stand out from the background image of the image which will typically be vegetation, an audience, the sky, the ground, etc. The often metallic composition of the shaft might also lead to a sharp color contrast with the background. Such features of the club can therefore enable machine vision recognition of the shaft. Similarly, the machine vision functions can be trained to recognize the limited number of club head-shapes and/or colors to enable their identification. Further still, these functions can be trained to identify the motion of the club associated with typical drives, chip shots, putts, etc. Thus, the machine vision circuits could be trained to recognize swings and to “mark” the location of the ball at the bottom of the down stroke and/or location of the golfer (with or without some offset).

FIG. 3 also illustrates that the system 300 can track which golf clubs 320 the golfer 328 is employing. For instance, each golf club 320 can have affixed thereto an RFID circuit 322 or other form of remote identification technology via which the system 300 can track the location of the golf clubs. For instance, the remote control 314 can include an RFID transponder capable of communicating with the RFID chips on the golf clubs 320. Thus, when the remote control 314 senses that a particular RFID chip has remained near it (while other RFID chips have moved (relatively) a pre-selected distance from itself), the remote control 314 can be configured to conclude that the golf club 320 to which the nearby chip is affixed is in use for a time for the current shot.

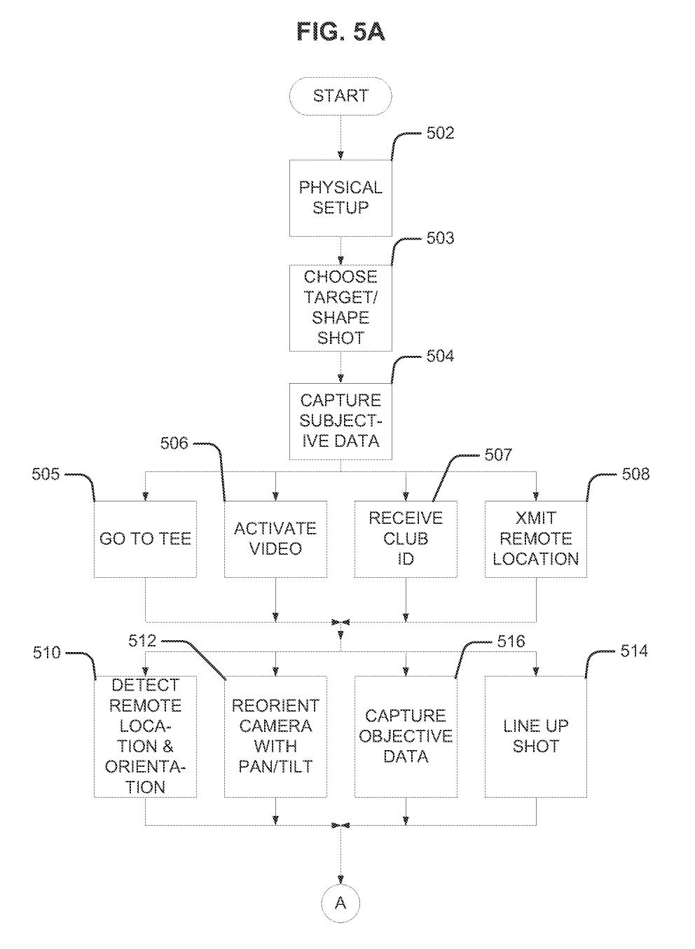

FIG. 4 illustrates a block diagram of a system for capturing data regarding athletic performances. Generally, FIG. 4 illustrates a mobile device and remote control of the current embodiment which are configured to collect objective and subjective date regarding an athlete's/athletes' athletic performance. More specifically, FIG. 4 illustrates a system 400, a mobile device 402, a remote control 404, an RFID circuit 406, a line of sight 408, a mobile application 410, a camera 411, an operating system 412, a geo-positioning application 414, a WiFi application 416, a graphic user Interface (GUI) 418, an orientation application 420, a pan/tilt unit 422, a remote control application 424, a WiFi application 426, a geo-positioning application 428, an RFID application 430, a start/stop button 432, pan/tilt controls 434, antennas 436, 438, 440, 442, and other supporting hardware.

The mobile device 402 comprises, hosts, houses, etc. the mobile application 410, the camera 411, the operating system 412, the geo-positioning application 414, the WiFi application 416, the graphic user Interface (GUI) 418, the orientation application 420 as well as other features. Indeed many of these features can be native/built-into the mobile device 402. These features are supported by various circuits, IC (integrated circuit) chips, sensors, etc. as those skilled in the art will appreciate. For instance, the camera 411 can be an onboard camera 411 built into the mobile device 402 by its manufacturer. Of course it could be an after-market modification, addition, etc. As such, it might operate at frame rates and/or with resolution/clarity relatively poorer than the high frame rate/high resolution capabilities of many heretofore available cameras used to capture video of golf ball flights. That is not to say that these cameras necessarily have relatively poor performance. But, that can be the case.

As FIG. 4 illustrates that the geo-positioning application 414 communicates with the antenna 436 to receive various geo-positioning signals such as GPS (Global Positioning System) signals, Global Navigation Satellite System (GLONASS), signals, European Union Galileo positioning system signals, Indian Regional Navigation Satellite System signals, Chinese Beidou Navigation Satellite System signals, etc. Thus, the geo-positioning application provides the mobile device 402 (and/or its operating system 412) with geo-positioning data for the mobile device 402. Of course, if desired, the WiFi application 416 could be used to obtain geo-positioning data for the mobile device 402 as well or in the alternative to the geo-positioning application. Of course, as disclosed elsewhere herein, machine vision and/or artificial intelligence functions can be used to locate the golfer and/or golf ball.

Regarding the WiFi application 416, in the current embodiment, it allows the mobile device 402 and applications resident thereon to communication with other WiFi devices within range of the mobile device 402. More specifically, the WiFi application 416 allows the mobile device 402 to communicate with the remote control 404. Thus, via the WiFi application, the mobile application 410 can exchange data with the remote control application 424 which can be resident on the remote control 404. Of course, BlueTooth® and/or other communications technologies could be used instead of or in addition to WiFi technology.

With continuing reference to FIG. 4, the GUI 418 can be presented to the user via a display (not shown in FIG. 4). It can also allow the user to view information supplied to, gathered by, etc. the mobile application 410. In the current embodiment, it can also allow the user to input subjective data regarding their play and to control the system 400. In some embodiments, moreover, it can provide a visual aid to assist the golfer in positioning the ball within the frame to facilitate processing of the video imagery of the shot(s).

The orientation application 420 can be configured to determine the orientation of the mobile device 402. For instance, it can sense accelerometers, compasses, etc. in the mobile device 402 to determine in which direction it points (for instance, north, east, south, west, and/or “points on the compass” there between). It can also inform the mobile application 410 whether the mobile device 402 is pointing up/down and/or to what degree.

Furthermore, the pan/tilt unit 422 can be mechanically and/or rigidly coupled to the mobile device 402 and an object likely to remain relatively near the player as the player traverses the golf course (or other terrain). It can therefore cause the mobile device to pan and/or tilt when it reorients itself in a corresponding manner. Furthermore, it can be configured to receive pan/tilt commands from the mobile application 410 and to respond thereto with/without feedback of its orientation to the same.

As to the mobile application 410, it controls the other features of the mobile device thereby allowing users to capture objective and subjective data regarding the user's play. And, in doing so, it often communicates with and/or relies on the operating system 412 to deliver data to it and/or to execute its commands. For instance, the mobile application communicates with the geo-positioning application 414 through the operating system 412 to obtain the geo-position of the mobile device 402. Further still, it communicates with the orientation application 420 to obtain data regarding the orientation of the mobile device 402 and/or camera 411. It also communicates with the WiFi application 416 to send commands/data to the remote control 404 and to receive commands/data therefrom. Furthermore, in the current embodiment, it communicates with the GUI 418 to exchange commands/data with the user and it communicates with the pan/tilt unit to exchange commands/data therewith.

FIG. 4 also illustrates the remote control 404 of the current embodiment. More specifically, the start/stop button 432 communicates with the remote control application to inform it that a user wishes to start/stop video recording of the user's play. The remote control application 424 also communicates with the pan/tilt controls (for instance, buttons) to determine whether the user wishes to manually control, re-orient, override, etc. the current settings being fed to the pan/tilt unit 422 by the system 400. Indeed, in some embodiments, the remote control application 424 is configured to send a command to the mobile application 410 via the WiFi application 426 to start/stop video recording should the user activate the start/stop button 432 (or some other user input device). Furthermore, the remote control application can send the geo-position of the remote control 404 to the mobile application along with, or in the alternative to, the start/stop command. It can also send pan/tilt controls to the mobile application 410 corresponding to user inputs received by the pan/tilt controls 434. Furthermore, in some embodiments, the remote control 404 includes/hosts a GUI configured to allow the user to input data into the system and/or to control the same. Thus, remote controls 404 configured with a GUI/display can allow a user to control the system “at the tee” and/or at other locations.

With reference still to FIG. 4, the RFID application 430 can communicate with RFID circuits 406 which are placed on the various golf clubs in the system 400. These RFID circuits 406 of embodiments transmit a code indicative of the identity of the clubs which they are individually attached/affixed to, embedded in, etc. Moreover, based on the strength of the signal(s) received from the RFID circuits 406, the remote control application can determine which golf club (that is RFID circuit 406) is moving (relative to itself), closest to it, farthest from it, etc. and therefore deduce which club the player is using. Similar functionality can be provided in the mobile device 402/mobile application 410 if desired. In such embodiments, therefore, the mobile application 410 and/or the remote control 404 can determine which club is in use and communicate that information to the other device/application.

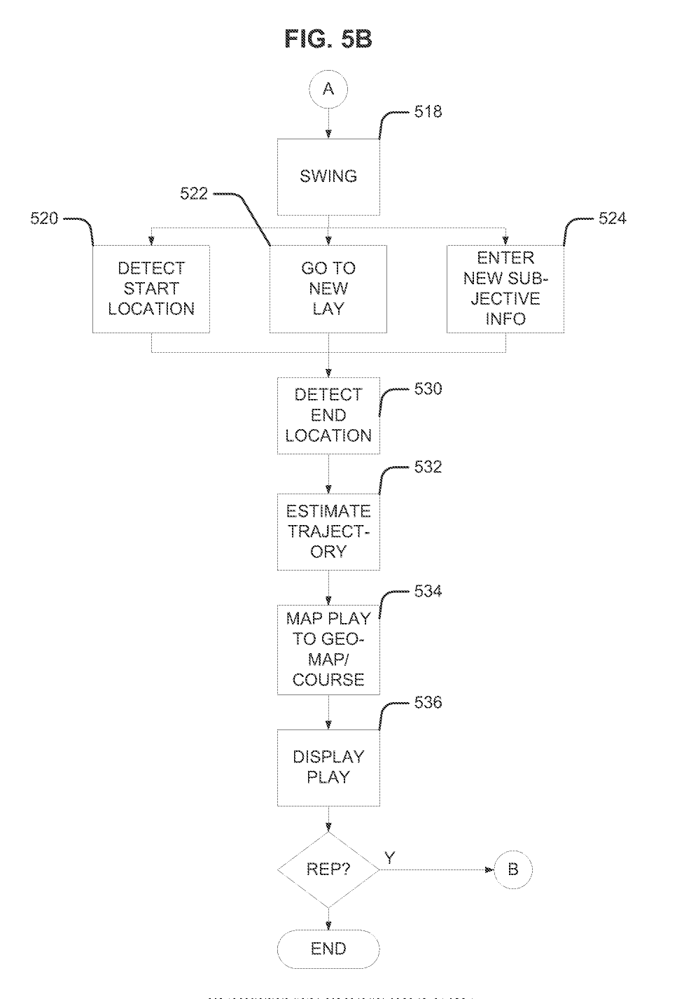

FIG. 5 illustrates a flowchart of a method for capturing data regarding athletic performances. In operation, systems 400 can operate as disclosed herein. In accordance with embodiments, method 500 includes various operations such as physically setting up a system 300 and/or 400. For instance, should a particular use of the system 300 be the first use for a particular game, the golfer 328 might place the golf bag 304 on the cart, could place it on the ground, or place it somewhere else. Moreover, the golfer 328 could place the carrier 306 in the golf bag with the gooseneck extending therefrom. Further, the golfer 328 might also place the mobile device 310 on the goose neck 308 and/or pan/tilt unit 311 with the camera 312 pointed generally toward the place where the golfer 328 expects to take the next shot. If desired, the player 28 could take the remote control 314 and attach it to their belt, strap it to their arm, or otherwise prepare to carry it to the location of the tee 316 or where the player expects to place the tee 316 (or where the ball 318 lays). Of course, at some point, it is likely that the player will select a golf club 320 for use in the shot. Thus, the golfer 328 can physically set up the system 300. See reference 502.

Often, golfers 328 will carefully consider the lay of the ball 318, the terrain 326, the location of the hole, etc. and select a target location for the shot. Moreover, players sometimes consider the potential presence of visual obstructions 324, other obstructions, hazards, etc. and, based therein (and using their experience, knowledge, etc. of the game/course), will select a shape shot for the shot. For instance, should an obstruction like a tree block a direct trajectory to the hole/target, the golfer 328 might aim the ball to one side of the obstruction and plan the shot such that the trajectory of the ball will take it around the obstruction and then cause it to come back toward the intended target. Reference 503 illustrates aspects of such considerations.

The intended target, shape shot, etc. represent subjective information about the shot not captured by otherwise heretofore available systems. In contrast, the mobile application 410 can be configured to allow the golfer 328 to enter such subjective information via the GUI 418 for storage in memory and/or subsequent review. See reference 504.

With continuing reference to FIG. 5, reference 505 illustrates that at some point the golfer 328 will approach the tee 316. As the golfer 328 does so, various activities occur within the system 300 and/or 400. For instance, the golfer 328 can press the start/stop button 432 to indicate that the system should begin capturing video of the impending shot as indicated at reference 506.

Moreover, the golfer 328 will typically be carrying the selected club 320 with a particular RFID circuit 322 attached thereto. That RFID circuit 322 will be transmitting a code identifying the club being carried and of course other RFID circuits on the other golf clubs 320 might be transmitting their codes as well. Furthermore, as the golfer 328 approaches the tee 316, the signals from those other chips will decrease as the distance between them and the remote control (with its RFID transponder) increases. The signal strength from the RFID circuit on the carried golf club 320 will therefore, in most situations, remain roughly constant and/or begin exceeding the signal strengths from the other RFID circuits 322 (see reference 5 7).

In addition, or in the alternative, the remote control 314 will be transmitting its geo-position to the mobile device 310. The mobile application 410 therein will, in embodiments, be storing a time stamped array of these geo-positions. See reference 508. The mobile application 410 can be communicating with the geo-positioning application 414 of the mobile device 402 to determine the location of the camera 411. It can also be communicating with the orientation application 420 of the mobile device 402 to determine the orientation of the mobile device 402 (and camera 411). Thus, the mobile application 410 can know the camera's location, the remote control's location, and the orientation of the camera 411. Since the golfer 328 will often be carrying the remote control 404, the mobile application 410 can equate the location of the remote control 404 with that of the golfer 328. As a result, the mobile application 410 can determine how to re-orient the camera 411 to frame the player and send corresponding commands to the pan/tilt unit 422. See reference 512.

At some time before/after the shot, the golfer 328 can enter subjective data regarding the shot via the GUI 418. More specifically, the player can enter subjective data such as the intended target location, the intended shape shot, their confidence/uncertainty level, notes regard the wind and/or other environmental data, etc.

Moreover, method 500 in accordance with embodiments, includes the golfer 328 lining up on the shot as illustrated at reference 516. Usually, this activity involves the player positioning themselves with respect to the tee 316, adjusting their grip on the golf club 320, positioning and/or orienting the golf club 320 with respect to the ball 318, etc. These activities take time and as a result the geo-position of the remote control 314 is likely to remain nearly stationary/constant for some time. Indeed, it is not unusual for a golfer 328 to spend 15 seconds or so “at the tee 316.” These, and/or other inputs, can be gathered via touch screens, soft controls, cursors, keyboards, trackballs, etc. See reference 514.

Of course, video capture might be ongoing during the foregoing activities and/or at other times. Thus, objective data regarding the shot (for instance, the video data) can be captured, stored, etc. as reference 516 indicates. Other objective data can include the location of the remote control 404/golfer 328, the location and/or orientation of the camera 411, etc. Of course, as reference 518 indicates, the golfer 328 will most often swing thereby propelling the ball with a drive, chip shot, putt, etc.

The location of the ball 318 can also be determined and stored as objective information. More specifically, the mobile application 410 can examine the time-stamped array of geo-positions for the remote control 404 and determine a relatively accurate approximation of the location of the ball 318. More specifically, the mobile application 410 can take advantage of characteristics of typical golfer 328 behavior. For instance, the mobile application 410 can examine the time-stamped geo-position data (for the remote control) and identify relatively lengthy pauses wherein these positions are approximately equal. Should there be more than one such pause, the mobile application can further examine the positions to determine the last such pause before the positions suddenly change and/or head back toward the mobile device 402. In other words, the mobile application can determine when the player has paused over the ball 318 and/or when the golfer 328 turns and heads back toward their golf bag 304/the mobile device 402. Since the golfer 328 and remote control 404 are in close proximity to the ball 318 at that time, the mobile application can use the remote control's location as a close enough approximation of the location of the ball 318 at the beginning of the shot. Reference 520, accordingly, indicates the mobile application 410 determining the starting location for the ball 318.

As play proceeds, the golfer 328 will eventually proceed to the lay of the ball 318 which they previously hit. See reference 522. Moreover, at some point, the golfer 328 can enter additional/new subjective data regarding the shot. For instance, the player could enter an indication of how well they felt that they executed the shot via the GUI 418. This information can be considered as additional subjective data regarding the shot, swing, play, performance, etc. Such activities are indicated at reference 524.

Furthermore, method 500 of FIG. 5 also includes obtaining an additional piece of objective data. And, with it, providing ball tracking capabilities heretofore not available. More specifically, as the player approaches the just-hit ball 318, the remote control 404 can continue to transmit its location to the mobile device 402. And, once the player again pauses over the ball 318, the mobile application 410 can detect that pause as disclosed elsewhere herein and use the corresponding location as the location for the ball 318 at the end of the just-concluded shot. See reference 530.

As a result, the mobile application 410 has access to three pieces of objective data that enable it to estimate the trajectory that the ball 318 took/followed during the shot far better and with less processing (and related) resources than heretofore possible. Indeed, the mobile application has reasonably good estimates of both the starting and ending locations of the ball 318 as well as many video frames of the ball as it is hit, leaves the tee 316 and begins to respond to the various phenomenon that affects its trajectory. In other words the mobile application of embodiments has an initial condition, an ending condition, and sample data for a portion of the trajectory from which it can estimate the ball's trajectory. The estimation can be by way of a machine vision application determining the 3-dimensional locations of the ball in each (or some) of the video frames and a curve fitting application using the resulting data to estimate the trajectory. See reference 532.

Thus, the system 300/400 can capture both subjective and objective data regarding particular shots. Of course it can also capture such information regarding an entire game for a particular player, a particular game for a group of players (with each remote control 404 possessing/transmitting a unique identifier), sets of games for players, etc. Moreover, it can store this information and allow it to be played back on the mobile device 402 or devices which receive the information it captures/generates. More specifically, as indicated at reference 536, the player can replay a shot, game, etc. as the mobile application 410 (or related applications) map it to the hole, course, etc. on which the play occurred. This re-play can include displaying the:
Information regarding where the play occurred (for instance, identifying the course, hole location on the fairway, etc.)
Subjective data captured regarding the play (for instance, the intended target and/or the intended shape shot.
Objective information regarding the play (for instance, the starting location of the ball 318 or golfer 328, the ending location of the ball 318, the captured video of the player's swing, the video of the ball as it leaves the tee, the estimated trajectory, etc.)

Moreover, if desired, method 500 can be repeated in whole or in part as indicated at reference 540. In accordance with some embodiments, method 500 can even be performed in a different order than illustrated by FIG. 5.

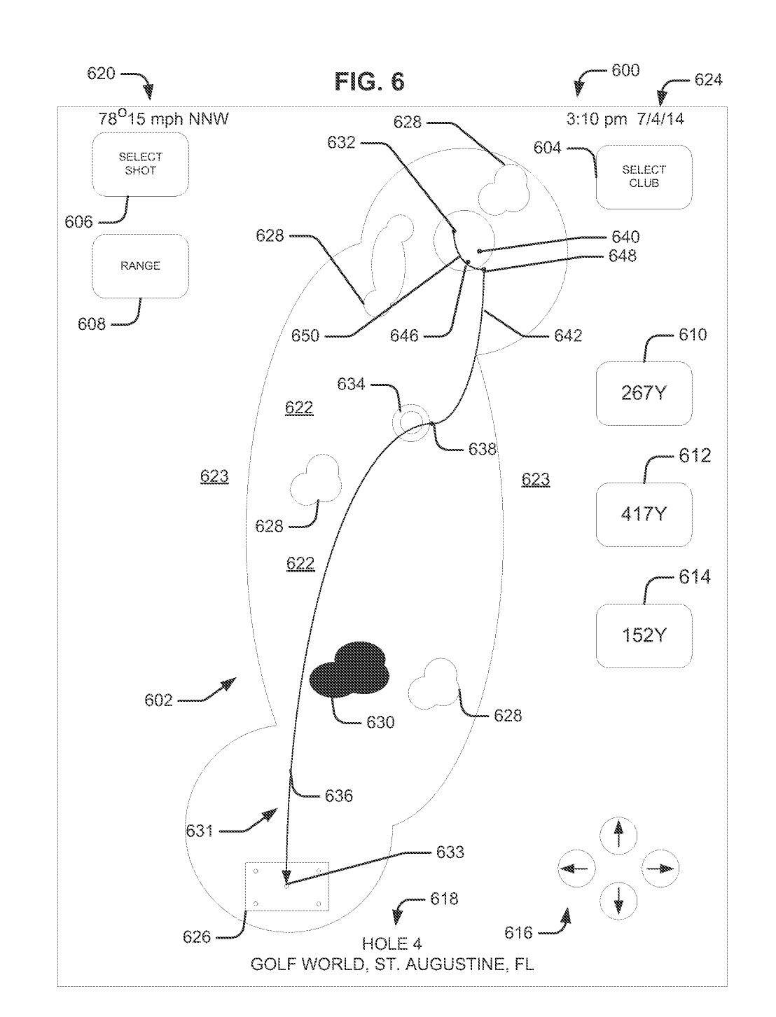

FIG. 6 illustrates a map of an athletic game. Generally, the GUI 418 can display the map so that the golfer 328 can see how well they executed their play on a particular shot, hole, course, etc. The GUI 418 can also accept golfer 328 input via various controls for items such as their selected targets, shot shapes, club selections, other subjective/objective information, etc. The GUI 418 can also display information related to the play. More specifically, FIG. 6 illustrates a GUI 600, a (satellite) map 602, a club selection control 604, a shot selection control 606, a range control 608, a range to cup 610, a range to target 612, a range difference 614, a navigation controls 616, location data 618, weather data 620, a time/date 624, a teeing ground 626, hazards 628, an obstruction 630, a cup 632, a tee 633, a fairway target 634, a fairway trajectory 636, a fairway lay 638, a greens target 640, a layup trajectory 642, a chip shot location 646, a greens lay 648, and a putt path 650.

The GUI 600 can display the satellite map 602 obtained from any available mapping service via the geo-positioning application 414 or WiFi application 416. In some embodiments, the GUI 600 displays a schematic and/or simplified map of the play instead of or in addition to a photographic map of the play. In the current embodiment, the satellite map 602 happens to show an entire hole from the teeing ground 626 to the cup 632 as well as some of the surrounding terrain. Thus, it shows the rough 623, various hazards 628, various obstructions 630, the tee 633 location, etc. as well. Thus, the golfer 328 can see where they played the particular hole shown.

Moreover, as FIG. 6 shows, the GUI 600 of the current embodiment also displays an indication of a particular play 631 include the drive(s), chip shots, putts, etc. More specifically, it shows where the player set the tee 633 on the teeing ground 626 and then the series of targets, trajectories, actual lays, etc. of the play. For instance, the GUI 600 overlays the estimated trajectory of the ball from the tee 633 to where it landed and stopped at the fairway lay 638. Also, in the current embodiment, so the golfer 328 can evaluate their performance the GUI 600 displays the fairway target 634 too. Note that the player executed a particular shot shape to “get around” the obstruction 630 which might have been a large tree.

During the currently displayed play 631, the golfer 328 appears to have then chosen to lay the ball up on the green as indicated by greens target 640. The golfer 328 then took a chip shot as indicated by the chip shot trajectory 643 and chip shot lay 646. Again, the greens target 640 is shown for player evaluation purposes and/or for other purposes. GUI 600 also displays the greens lay 648 and the putt path 650 that scored the hole for that player. In regard to tracking the ball, the putt path can be considered to be somewhat similar to the various ball trajectories as disclosed further elsewhere herein. Note, that in some embodiments, the GUI 600 can display the play 631 of more than one golfer 328. Again, the golfers 328 can use these plays 631 as displayed to evaluate each other's performance, for enjoyment, etc.

With continuing reference to FIG. 6, the GUI 600 has a number of controls and displays a variety of other information. For instance, the club selection control 604 allows the golfer 328 to click on, touch, cursor too, etc. it and thus navigate to a different page of the GUI 600 to enter their club selection (a piece of objective data). Controls (for instance, buttons, drop down lists, pop up lists, selection wheels, etc.) can be provided on that page to enable the user to do so. Similarly, shot selection control 606 allows golfers 328 to input their shot selection (a piece of subjective information) for particular shots.

In contrast, the range control 608 allows a user to request various data related to the range (or distance) to various points on the hole. More specifically, activating that control can cause the GUI 600 to display, update, estimate, etc. the range to the cup 610, the range to the (current) target 612, the range difference 614 there between, etc.

With ongoing reference to FIG. 6, the GUI of the current embodiment also includes navigation controls 616 for navigate to pages which are located “up” and/or “down” or otherwise in the hierarchy of pages of the GUI 600. The GUI 600 can also include navigation controls for moving back to the “previous” page and/or forward to the next one. Of course, some navigation controls 616 could be supplied for jumping to favorite pages, often visited pages, between holes, between shots, focusing on particular shots/locations, etc.

Furthermore, GUI 600 of the current embodiment displays various information that might be of interest to the golfer 328 during and/or after the play 631. For instance, GUI 600 can display data regarding where each shot took place. That location data 618 can include the country, state, city, golf course, hole, position on the hole, etc. if desired. Weather data 620 such as temperature, humidity, visibility, wind speed, wind direction, wind variability, etc. can be displayed by GUI 600. The weather data 620 can be obtained from weather forecasting/reporting services while the location and related data (e.g. elevation) can be obtained from various geo-positioning services. Moreover, while a shot/play 631 is being played back from memory such location and weather data 618 and 620 can be displayed if desired.

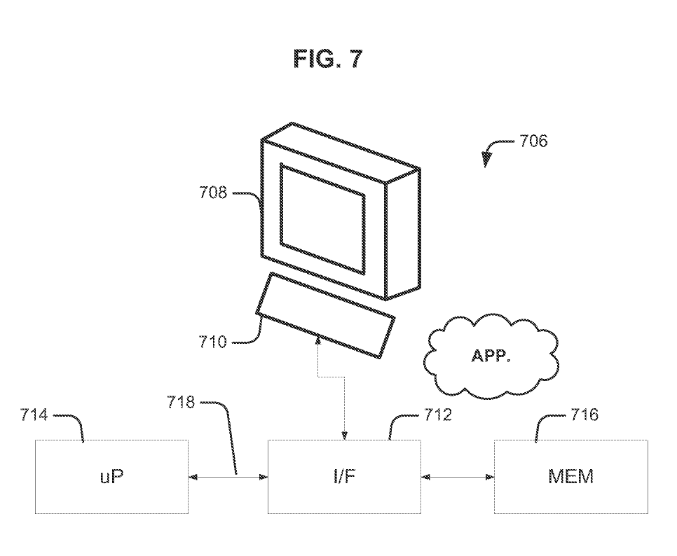

FIG. 7 illustrates a computer for use in capturing data regarding athletic performances. Indeed, the computer 706 could host an application 730 for presenting GUIs (and processing the associated data). In some cases, the computer 706 could include/provide some or all of the components of the remote controls, controllers, etc. disclosed herein although the computer 706 could be implemented in analog hardware, firmware, ASICs (application specific integrated circuits), RISC (reduced instruction set integrated circuits), etc.

At this juncture a few words might be in order about the computer(s) 706 and/or other systems, apparatus, etc. used to design, store, host, recall, display, transmit, receive, etc. programs, applications, controllers, algorithms, routines, codes, GUIs, etc. of embodiments. The type of computer 706 used for such purposes does not limit the scope of the disclosure but certainly includes those now known as well as those which will arise in the future. But usually, these computers 706 will include some type of display 708, keyboard 710, interface 712, processor 714, memory 716, and bus 718.

Indeed, any type of human-machine interface (as illustrated by display 708 and keyboard 710) will do so long as it allows some or all of the human interactions with the computer 706 as disclosed elsewhere herein. Similarly, the interface 712 can be a network interface card (NIC), an RFID transceiver, a WiFi transceiver, an Ethernet interface, etc. allowing various components of computer 706 to communicate with each other and/or other devices. The computer 706, though, could be a stand-alone device without departing from the scope of the current disclosure.

Moreover, while FIG. 7 illustrates that the computer 706 includes a processor 714, the computer 706 might include some other type of device for performing methods disclosed herein. For instance, the computer 706 could include a microprocessor, an ASIC (Application Specific Integrated Circuit), a RISC (Reduced Instruction Set IC), a neural network, etc. instead of, or in addition, to the processor 714. Thus, the device used to perform the methods disclosed herein is not limiting.

Again with reference to FIG. 7, the memory 716 can be any type of memory currently available or that might arise in the future. For instance, the memory 716 could be a hard drive, a ROM (Read Only Memory), a RAM (Random Access Memory), flash memory, a CD (Compact Disc), etc. or a combination thereof. No matter its form, in the current embodiment, the memory 716 stores instructions which enable the processor 714 (or other device) to perform at least some of the methods disclosed herein as well as (perhaps) others. The memory 716 of the current embodiment also stores data pertaining to such methods, user inputs thereto, outputs thereof, etc. At least some of the various components of the computer 706 can communicate over any type of bus 718 enabling their operations in some or all of the methods disclosed herein. Such buses include, without limitation, SCSI (Small Computer System Interface), ISA (Industry Standard Architecture), EISA (Extended Industry Standard Architecture), etc., buses or a combination thereof. With that having been said, it might be useful to now consider some aspects of the disclosed subject matter.

Thus, systems have been provided which allow users to capture video of their athletic performances in convenient, user-friendly, hands-free manners. Moreover, systems of embodiments estimate the trajectory of the balls, pucks, and/or other projectiles used in these athletic performances with more accuracy while using fewer computing resources than heretofore possible. Systems of embodiments also capture objective data (such as video) and user observed data, as well as subjective information thereby providing additional capabilities and a holistic capturing of the athletic performances. As a result, users can review an integrated set of data regarding their performance and, hopefully, improve their game to a greater degree and in less time than heretofore possible.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A system for capturing athletic performance data comprising:
a remote control configured to be carried by a user and further comprising a geo-location circuit configured to determine a geo-location of the remote control and a user input which when activated causes the remote control to transmit a signal indicative thereof and a signal indicative of the geo-location; and
a controller to be in communication with the remote control and further comprising a processor and a memory storing processor executable instructions which when executed by the processor cause the processor to perform a method further comprising
detecting the signal indicative of a user input activation and
responsive thereto storing the geo-location in the memory and sending a signal indicating that video of the athletic performance should be captured.

2. The system of claim 1 further comprising a video capture device configured to receive the signal indicating that video should be captured.

3. The system of claim 2 wherein the video capture device is selected from a group consisting of a smart telephone, computing device, or a device and apparatus specifically constructed for the purpose described herein.

4. The system of claim 1 further comprising a pan and tilt unit and wherein the method further comprises causing the pan and tilt unit to point toward a location selected from the group consisting of the geo-location, a desired subject, and a user-selected location on the playing field.

5. The system of claim 5 wherein the method further comprises receiving a plurality of time stamped geo-locations from the remote control and analyzing the plurality of time stamped geo-locations to determine a particular geo location at which the movement of the remote control paused for a pre-selected time.

6. The system of claim 5 wherein the method further comprises capturing video of an initial trajectory of a ball.

7. The system of claim 6 wherein the method further comprises receiving a geo location of the ball at the end of the trajectory of the ball.

8. The system of claim 7 wherein the method further comprises estimating the trajectory of the ball based on the geo location at which the remote control paused, the video of the initial trajectory of the ball, and the geo location of the ball at the end of the trajectory.

9. The system of claim 1 wherein the method further comprises accepting a user selected intended target for a ball.

10. The system of claim 1 wherein the method further comprises accepting a user selected intended shot shape for a ball.

11. A method for capturing athletic performance data comprising:
detecting the signal indicative of a user input activation from a remote control configured to be carried by a user and further comprising a geo-location circuit configured to determine a geo-location of the remote control and a user input which when activated causes the remote control to transmit the signal indicative of a user activation thereof and a signal indicative of the geo-location; and
responsive to the signal indicative of the user activating the user input storing the geo-location in a memory and sending a signal indicating that video of the athletic performance should be captured using a processor in communication with the remote control and memory.

12. The method of claim 10 further comprising receiving the signal indicating that video should be captured using a video capture device.

13. The method of claim 12 wherein the video capture device is selected from the group consisting of a smart telephone and a computing device.

14. The method of claim 10 further comprising causing a pan and tilt unit to point toward a location selected from the group consisting of the geo-location, a desired subject, and a user-selected location on the playing field.

15. The method of claim 14 further comprising receiving a plurality of time stamped geo-locations from the remote control and analyzing the plurality of time stamped geo-locations to determine a particular geo location at which the remote control paused for a pre-selected time.

16. The method of claim 14 further comprising capturing video of an initial trajectory of a ball.

17. The method of claim 15 further comprising receiving a geo location of the ball at the end of the trajectory of the ball.

18. The method of claim 11 further comprising accepting a user selected intended target for a ball.

19. The method of claim 11 further comprising accepting a user selected intended shot shape for a ball.

20. The method of claim 11 further comprising accepting a user selected type of club for a shot.

21. The method of claim 11 further comprising accepting a user selected set of observed natural conditions.

22. The method of claim 11 further comprising determining one or more types of clubs and presenting the determined types of clubs to a user.

23. The method of claim 11 further comprising determining a type of shot played on a shot.

24. The method of claim 11 further comprising presenting a visual cue to a user whereby the user to orient a video capture device in such a manner that the video capture device to frame a ball.

25. The method of claim 11 further comprising accepting a user-input score for at least a hole.

26. The method of claim 11 further comprising determining a score of a user for at least one hole.

27. A system for capturing athletic performance data comprising:
a remote control configured to be carried by a user and further comprising a geo-location circuit configured to determine geo-location of the remote control and a user input which when activated causes the remote control to transmit a signal indicative thereof and a signal indicative of the geo-location;
a controller to be in communication with the remote control and a further comprising a processor and a memory storing processor executable instructions which when executed by the processor cause the processor to perform a method further comprising
detecting the signal indicative of a user input activation and
responsive thereto storing the geo-location in the memory and sending a signal indicating that video should be captured;
a video capture device configured to receive the signal indicating that video should be captured wherein the video capture device is a smart telephone; and
a pan and tilt unit and wherein the method further comprises causing the pan and tilt unit to point toward the geo-location;
wherein the method further comprises
receiving a plurality of time stamped geo-locations from the remote control and analyzing the plurality of time stamped geo-locations to determine a particular geo location at which the remote control paused for a pre-selected time,
capturing video of an initial trajectory of a ball,
receiving a geo location of the ball at the end of the trajectory of the ball,
estimating the trajectory of the ball based on the geo location at which the remote control paused, the video of the initial trajectory of the ball, and the geo location of the ball at the end of the trajectory,
accepting a user selected intended target for a ball,
accepting a user selected intended shot shape for a ball,
accepting user-selected and observed conditions for a given shot,
determining a club to be recommended for a shot,
outputting an indication of the recommended club,
accepting an indication of a club selection for the shot,
determining a type of shot played by the user during the shot, and
calculating a score for a particular hole, and
accepting a user-input score.
